(19) United States
(12) Patent Application Publication
(10) Pub. No.: US 2017/0355297 A1
(43) Pub. Date: Dec. 14, 2017

(54) Cargo Tie-Down

(71) Applicant: Thule, Inc., Seymour, CT (US)

(72) Inventor: Thomas CHIMENTI, Fairfield, CT (US)

(21) Appl. No.: 15/180,878

(22) Filed: Jun. 13, 2016

(51) Int. Cl. B60P 7/08

(52) U.S. Cl. CPC B60P 7/0807

(57) ABSTRACT

A tie-down assembly for a vehicle includes a bolt having a head and a shaft and a face plate having an aperture configured to receive the bolt therethrough. A carrier includes an attachment surface configured to engage the faceplate and a first stop tab. A lock plate is configured to be disposed about the bolt comprising and includes an aperture configured to receive the bolt therethrough. A first edge of the lock plate is configured to engage the first stop tab, thereby preventing rotational movement of the lock plate in a first direction.

### BACKGROUND

### Field

The present disclosure relates to tie-down assemblies and anchoring systems. More specifically, the present disclosure relates to tie-down assemblies and anchoring systems for cargo being transported by a vehicle.

### Background

Vehicles are often used for transporting loads, freight, cargo, equipment, goods, etc. For example, cargo can be transported in the bed of a pickup truck. In order to secure the load, it is advantageous to have tie-down points for ropes, straps, hooks, bungee cords, etc. Certain vehicles have tie-down points that allow the insertion and securement of tie-down assemblies into pre-designated holes located in a wall of the truck bed. Inserting and attaching a tie-down assembly can be difficult due to the small amount of space within the wall of the vehicle truck bed. It can also be difficult to secure the tie-down assembly within the hole at the tie-down point because the user does not have physical or visual access to the interior of the wall to help manipulate the rear of the tie-down assembly, which is disposed in the interior of the wall.

### BRIEF SUMMARY

In certain embodiments, a tie-down assembly for a vehicle can include a bolt having a head and a shaft, a face plate having an aperture configured to receive the bolt therethrough, a carrier, and a lock plate. The carrier can include an attachment surface configured to engage the face plate, a first extension portion extending from the attachment surface, the first extension portion having a first stop tab, and an aperture configured to receive the bolt therethrough. The lock plate can be configured to be disposed about the bolt. The lock plate can include an aperture configured to receive the bolt therethrough and a first edge configured to engage the first stop tab of the first extension portion, thereby preventing rotational movement of the lock plate in a first direction. In certain embodiments, a spring can be disposed around the shaft of the bolt between the carrier and the lock plate.

In certain embodiments, the bolt can be an eye-bolt and the head can include an aperture. In certain embodiments, the head of the bolt can include a base having an interior surface configured to face or contact the face plate. In certain embodiments, the shaft of the bolt can be threaded. In certain embodiments, the aperture of the lock plate can be threaded and the shaft of the bolt can be configured to rotate within the aperture of the lock plate. In certain embodiments, the bolt can be configured to rotate within the aperture of the lock plate when the first edge of the lock plate is engaged with the first stop tab of the first extension portion.

In certain embodiments, the bolt can include a stop member at a distal end of the shaft. In certain embodiments, the stop member can be configured to be disposed in a groove in a rear surface of the lock plate. In certain embodiments, the stop member can be a pin disposed through a hole in the distal end of the shaft. In certain embodiments, the pin can have a first end and a second end that extend out of the hole. In certain embodiments, the ends of the pin can be configured to be disposed in a groove in a rear surface of the lock plate.

In certain embodiments, the stop member can be a clip disposed around the distal end of the shaft. In certain embodiments, the clip can be disposed entirely around a circumference of the distal end of the shaft.

In certain embodiments, an exterior surface of the face plate can have a raised portion and an interior surface having a corresponding indentation. In certain embodiments, the carrier can be configured to be disposed within the indentation of the interior surface.

In certain embodiments, the carrier can include a second extension portion extending from the attachment surface. The second extension portion can include a second stop tab. In certain embodiments, a second edge of the lock plate can be configured to engage the second stop tab of the second extension portion, thereby preventing rotational movement of the lock plate in the first direction.

In certain embodiments, the carrier can include one or more protrusions extending from the attachment surface. The protrusions can be configured to mate with one or more corresponding through-holes in the face plate to releasably couple the carrier with the face plate. In certain embodiments, at least one protrusion can have an extension portion and a flange disposed at an end of the extension portion. The flange can protrude through a corresponding through-hole in the face plate.

In certain embodiments, the first edge of the lock plate can have a first notch. In certain embodiments, the first notch can be configured to engage the first stop tab of the first extension portion, thereby preventing rotational movement of the lock plate in a second direction. In certain embodiments, the second edge of the lock plate can have second a notch. In certain embodiments, the second notch can be configured to engage the second stop tab of the second extension portion, thereby preventing rotational movement of the lock plate in the second direction.

In certain embodiments, the face plate can be configured to contact an exposed surface of a wall of the vehicle. In certain embodiments, the lock plate and at least a portion of the carrier can be configured to be disposed in a void space within the wall of the vehicle.

In certain embodiments, the bolt can be configured to receive an attachment element. In certain embodiments, the attachment element can be a rope.

In certain embodiments, an anchoring system can include a bolt having a head with an aperture and a threaded shaft. The anchoring system can include a face plate having an aperture configured to receive the shaft therethrough, where the face plate is configured to contact a first side of a wall. The anchoring system can also include a carrier and a lock plate. In certain embodiments, the carrier can be coupled to the face plate. In certain embodiments, the carrier can include a first stop tab and an aperture configured to receive the shaft therethrough. In certain embodiments, at least a portion of the carrier can be configured to be disposed on a second side of the wall. In certain embodiments, the lock plate can include an aperture having threading, and the shaft can be configured to rotate within the aperture of the lock plate. In certain embodiments, a first edge of the lock plate can be configured to engage the first stop tab upon rotation of the bolt in a first direction, thereby preventing rotational movement of the lock plate in the first direction. In certain embodiments, the lock plate can be configured to be disposed on the second side of the wall.

In certain embodiments, the wall can be a wall of a vehicle. In certain embodiments, the wall of the vehicle can be the wall of a truck bed.

In certain embodiments, rotation of the bolt in the first direction can move the lock plate along the shaft of the bolt in a direction toward the face plate. In certain embodiments, the lock plate can engage the first stop tab at 90 degrees of rotation. In certain embodiments, the lock plate can be disposed in a first configuration during insertion through an aperture in the wall, and the lock plate can be disposed in a second position upon rotation in the first direction such that the lock plate engages the first stop tab. In certain embodiments, the second position can be perpendicular to the first position.

In certain embodiments, the carrier can include a second stop tab and a channel between the first stop tab and the second stop tab. In certain embodiments, a second edge of the lock plate can be configured to engage the second stop tab upon rotation of the bolt in the first direction. In certain embodiments, rotation of the bolt in the first direction can move the lock plate along the shaft in a direction toward the face plate within the channel. In certain embodiments, the lock plate can be prevented from rotating in a second direction opposite the first direction when the lock plate is disposed in the channel. In certain embodiments, the first direction can be counter-clockwise.

In certain embodiments, a method of attaching a tie-down assembly to a vehicle can include providing a tie-down assembly. The tie-down assembly can include a bolt having a head and a threaded shaft, a face plate having an aperture configured to receive the bolt therethrough, a carrier detachably coupled to the face plate having an aperture configured to receive the bolt therethrough and a first extension portion having a first stop tab, and a lock plate having a first edge configured to engage the first stop tab of the first extension portion and a threaded aperture configured to rotatably receive the bolt therethrough. In certain embodiments, the method can include inserting the tie-down assembly through a hole in a wall of the vehicle such that the face plate contacts a first side of the wall, at least a portion of the carrier is disposed on a second side of the wall, and the lock plate is disposed on the second side of the wall in a first orientation. In certain embodiments, the method can include rotating the bolt such that the lock plate rotates in a first direction to a second orientation where the first edge of the lock plate engages the first stop tab and such that lock plate moves along the shaft of the bolt in a direction toward the face plate. In certain embodiments, the first direction can be counter-clockwise. In certain embodiments, the lock plate can remain in the second orientation when rotating the bolt after engaging the first stop tab. In certain embodiments, rotating the bolt can secure the tie-down assembly to the wall of the vehicle.

### BRIEF DESCRIPTION OF THE DRAWINGS/FIGURES

The accompanying drawings, which are incorporated herein form part of the specification, illustrate the embodiments and, together with the description, further serve to explain the principles of the embodiments and to enable a person skilled in the relevant art(s) to make and use the embodiments.

FIG. 1 illustrates an exploded view of a tie-down assembly, according to an embodiment.

FIG. 2 illustrates a perspective view of a tie-down assembly, according to an embodiment.

FIG. 3 illustrates a rear perspective view of a tie-down assembly, according to an embodiment.

FIG. 4 illustrates a perspective view of a tie-down assembly, according to an embodiment.

FIG. 5 illustrates a cross-sectional view of a tie-down assembly, according to an embodiment.

FIG. 6 illustrates a bolt, according to an embodiment.

FIG. 7 illustrates a bolt, according to an embodiment.

FIG. 8 illustrates a perspective view of a face plate, according to an embodiment.

FIG. 9 illustrates a perspective view of a face plate and a carrier, according to an embodiment.

FIG. 10 illustrates a rear perspective view of a face plate, according to an embodiment.

FIG. 11 illustrates a perspective view of a carrier, according to an embodiment.

FIG. 12 illustrates a rear perspective view of a carrier, according to an embodiment.

FIG. 13 illustrates a perspective view of a lock plate, according to an embodiment.

FIG. 14 illustrates a rear perspective view of a lock plate, according to an embodiment.

FIG. 15 illustrates an exploded view of a tie-down assembly, according to an embodiment.

FIG. 16 illustrates a perspective view of a tie-down assembly, according to an embodiment.

FIG. 17 illustrates a side view of a tie-down assembly, according to an embodiment.

FIG. 18 illustrates a perspective view of face plate and a carrier, according to an embodiment.

FIG. 19 illustrates a rear perspective view of a tie-down assembly, according to an embodiment.

FIG. 20 illustrates a vehicle having a tie-down assembly in a wall of the truck bed, according to an embodiment.

FIG. 21 illustrates a tie-down assembly installed in a wall of a vehicle, according to an embodiment.

FIG. 22 illustrates a perspective view of a tie-down assembly installed in a wall of a vehicle, according to an embodiment.

FIG. 23 illustrates a cross-sectional view of a tie-down assembly installed in a wall of a vehicle, according to an embodiment.

FIG. 24 illustrates a rear perspective view of a tie-down assembly installed in a wall of a vehicle in an insertion configuration, according to an embodiment.

FIG. 25 illustrates a rear perspective view of a tie-down assembly in a wall of a vehicle in a transitional configuration, according to an embodiment.

FIG. 26 illustrates a rear perspective view of a tie-down assembly installed in a wall of a vehicle in a secured configuration, according to an embodiment.

FIG. 27 illustrates an exploded view of a tie-down assembly, according to an embodiment.

FIG. 28 illustrates a side view of a tie-down assembly, according to an embodiment.

FIG. 29 illustrates a rear perspective view of a tie-down assembly, according to an embodiment.

FIG. 30 illustrates a rear perspective view of a face plate, according to an embodiment.

FIG. 31 illustrates a perspective view of a carrier, according to an embodiment.

FIG. 32 illustrates a rear perspective view of a carrier, according to an embodiment.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

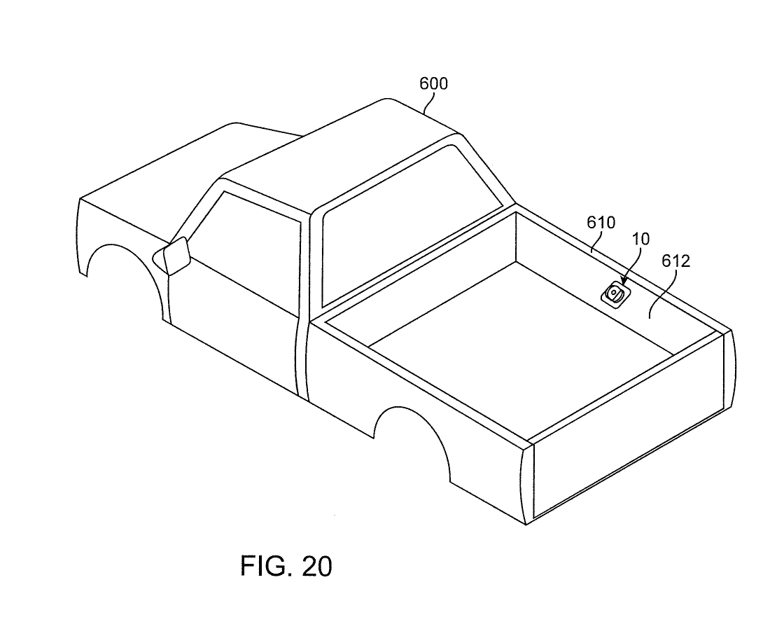

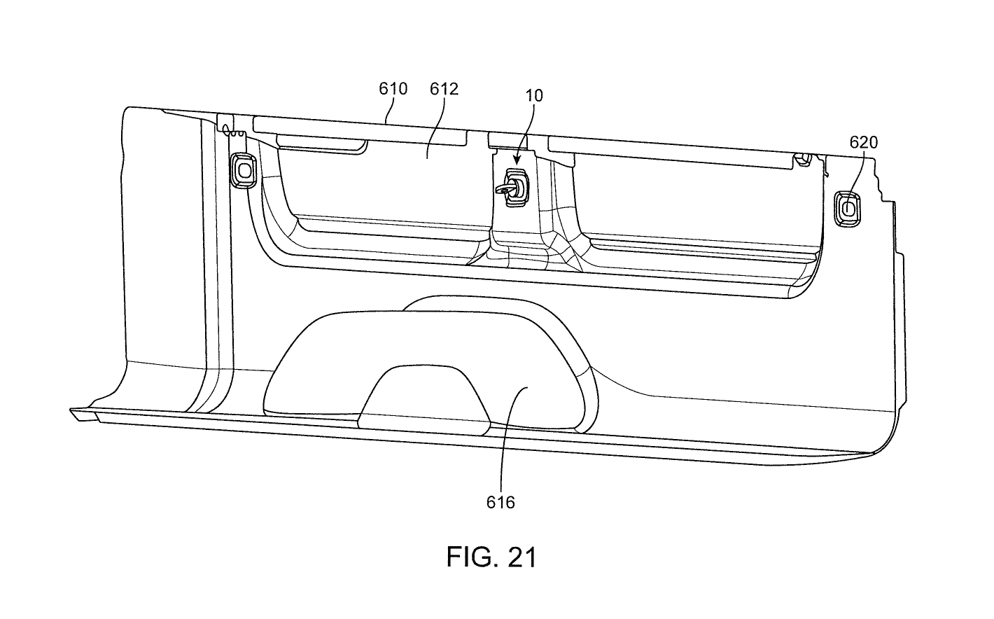

The tie-down assemblies 10 disclosed herein are described with reference to a vehicle, for example, a pickup truck. More specifically, as shown, for example, in FIGS. 20 and 21, the tie-down assemblies can be fastened within a hole 620 in a wall 610 of a vehicle 600. However, the tie-down assemblies 10 may be used as an anchoring system in other environments, for example, but not limited to an interior or exterior wall of a building or other structure, a storage container (e.g., a toolbox or cargo box), or a piece of furniture (e.g., a bookcase, a shelving unit, or a desk). Within the vehicle environment, the tie-down assembly 10 can be disposed in locations on the vehicle other than the interior of a truck bed wall 610. For example, the tie-down assembly can be disposed on an exterior side of the vehicle, including on a door, hood, side panel, tailgate, or any other portion of a vehicle where it may be useful to have a securement point.

Tie-down assembly 10 can be used as a tie-down or securement point for ropes, straps, hooks, bungee cords, etc. to secure a load on a vehicle. These tie-down points can include a pre-fabricated hole 620, for example, in a wall 610 of the interior of the truck bed, as shown in FIGS. 20 and 21. The truck bed can have multiple holes 620, so that one or more tie-down assembly 10 can be disposed at various locations depending on the size, shape, and nature of the load to be secured.

Generally, inserting and attaching a tie-down assembly can be difficult due to the small amount of room within the wall of a vehicle truck bed. The wall typically has an interior panel (i.e., the interior of the truck bed) and an exterior panel (i.e., the exterior side panel of the vehicle), with a void space in between. This void space is typically less than 2 inches in width between the interior and exterior panels of the wall. In some vehicle models, the void space can be 1 inch or less. This small space can make it difficult to secure a tie-down assembly to the wall of the vehicle, particularly because the tie-down assembly must be secured firmly enough to withstand heavy loads, for example, up to 250 pounds. It can also be difficult to secure the tie-down assembly within the hole at the tie-down point because the user does not have access to the interior of the vehicle wall to see or manipulate the rear of the tie-down assembly, which is disposed in the interior void space of the wall.

As described in further detail herein, embodiments of the disclosed tie-down assemblies 10 provide one or more advantages over present devices, which often require bulky “butterfly” designs, similar to a wall molly, and are unable to fit within smaller void spaces in vehicle walls. For example, embodiments of the tie-down assemblies 10 are smaller in depth and can therefore fit within smaller void spaces in vehicle walls. This is accomplished, for example, by the unique configuration of the carrier 300 and lock plate 400, which minimizes the size during the insertion configuration of the tie-down assembly 10. The smaller size means that the tie-down assemblies 10 can be used with a greater variety of vehicle models.

Another advantage of the tie-down assemblies 10 described herein is that the assembly is prevented from becoming disassembled while disposed within the wall of the vehicle. Upon unfastening traditional tie-down assemblies, because the portion of the assembly in the interior of the wall is hidden from view, it is easy to over-rotate the bolt portion, resulting in the “butterfly” clamp falling off the end of the bolt and into the interior void space of the wall, where it cannot be retrieved. The tie-down assemblies 10 described herein can include a stop member 126, which can prevent the lock plate 400 from becoming unthreaded from the shaft 120 of the eye-bolt 100, thereby preventing unwanted disassembly.

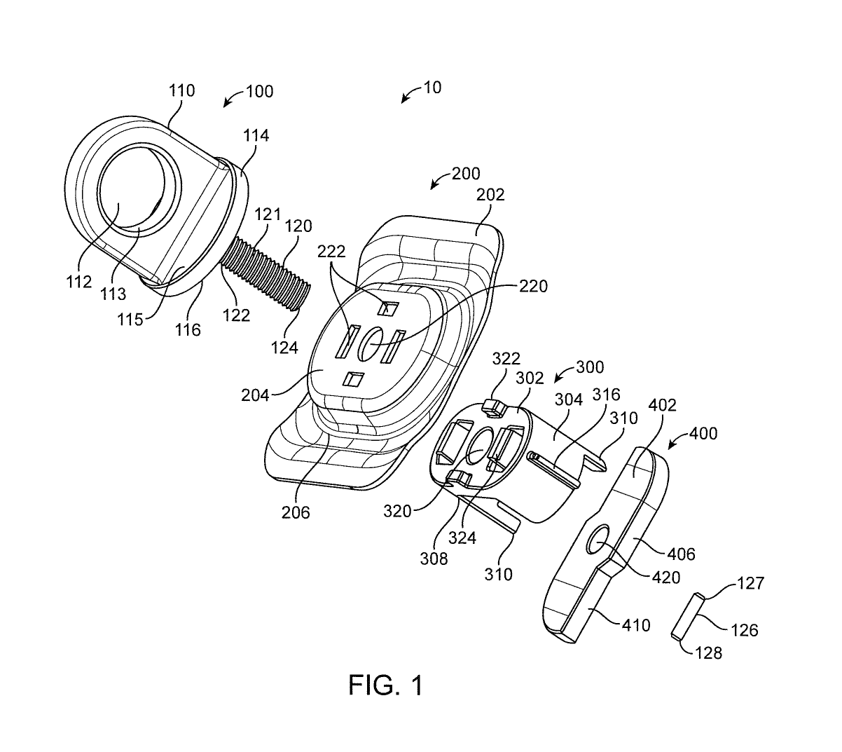

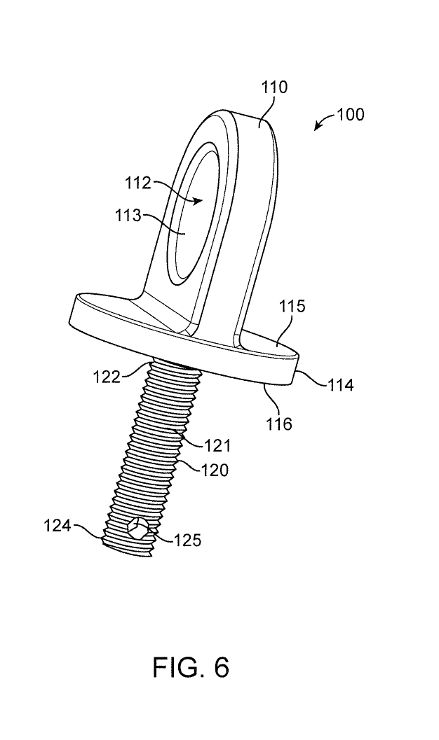

FIG. 1 illustrates an exploded view of tie-down assembly 10, according to an embodiment. In the embodiment shown in FIG. 1, the primary components of tie-down assembly 10 are bolt 100 (e.g., an eye-bolt), face plate 200, carrier 300, and lock plate 400. Each of these primary components and additional components will be described herein in detail with reference to the figures. In particular, FIGS. 6-14 illustrate embodiments of each component.

FIG. 6 illustrates bolt 100, according to an embodiment. In certain embodiments, bolt 100 can be an eye-bolt. A person of skill in the art would understand that where bolt 100 is referred to as an “eye-bolt,” another type of bolt can be used and the embodiment is not limited to an eye-bolt. Eye-bolt 100 can include head 110 and shaft 120. Head 110 can be used as a gripping point to rotate eye-bolt 100. In certain embodiments, head 110 can include an eye 112, which can be an aperture through head 110. Eye 112 can include an inner rim 113. The head 110 of eye-bolt 100 can provide a tie-down point for attaching ropes, straps, hooks, bungee cords, etc. to tie-down assembly 10. For example, a hook, clip, or carabineer can extend through eye 112 and engage with inner rim 113 of head 110 when an attached rope is pulled taught. An end of the rope itself can be fed through eye 112 and the rope can be tied directly to head 110.

Eye-bolt 100 can be made of any suitable material, for example, metal. In certain embodiments, eye-bolt 100 can be steel. Generally, eye-bolt 100 should be made of a material strong enough to withstand the tension and load forces placed on eye-bolt 100 by the attachment devices and loads that will be secured to tie-down assembly 10 via eye-bolt 100.

In certain embodiments, eye-bolt 100 can include base 114 having an exterior surface 115 and an interior surface 116. In certain embodiments, base 114 can be generally circular. Exterior surface 115 is visible when eye-bolt 100 is assembled to the wall of a vehicle. Interior surface 116 can face the face plate 200 and be disposed in contact with the face plate 200 when tie-down assembly 10 is assembled. In certain embodiments, interior surface 116 can be disposed in contact with one or more portions of carrier 300 (e.g., clips 324 and/or protrusions 322) extending through holes 222 of face plate 200. In this manner, these portion(s) of carrier 300 can act as a bearing surface for base 114 as eye-bolt 100 is rotated to fasten the tie-down assembly 10 to the wall of a vehicle.

Eye-bolt 100 can include an elongated shaft 120 extending from head 110 and/or base 114. The size and shape (e.g., diameter) of shaft 120 can be configured to fit through apertures 220, 320, and 420 in face plate 200, carrier 300, and lock plate 400, respectively. For example, in certain embodiments, shaft 120 can be cylindrical and apertures 220, 320, and 420 can be circular. A proximal end 122 of shaft 120 can extend from base 114. In certain embodiments, shaft 120 can include threading 121, which can correspond to threading on lock plate 400, thereby allowing lock plate 400 to be translated along shaft 120 upon rotating eye-bolt 100. In certain embodiments, a length of shaft 120 can be less than 2 inches so that tie-down assembly 10 can be secured to a wall 610 having an interior void space that is less than 2 inches between the interior and exterior panel of the wall. In certain embodiments, the length of shaft 120 can be 1 inch or less so that tie-down assembly 10 can be secured to a wall 610 having an interior void space that is 1 inch or less between the interior and exterior panel of the wall.

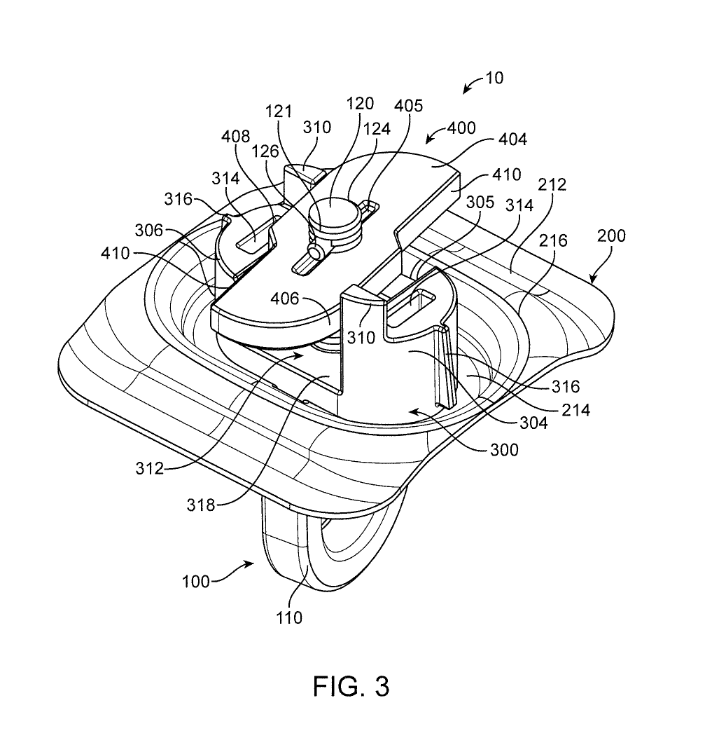

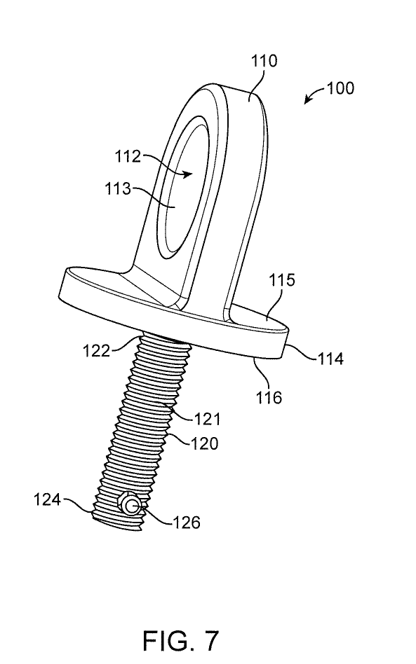

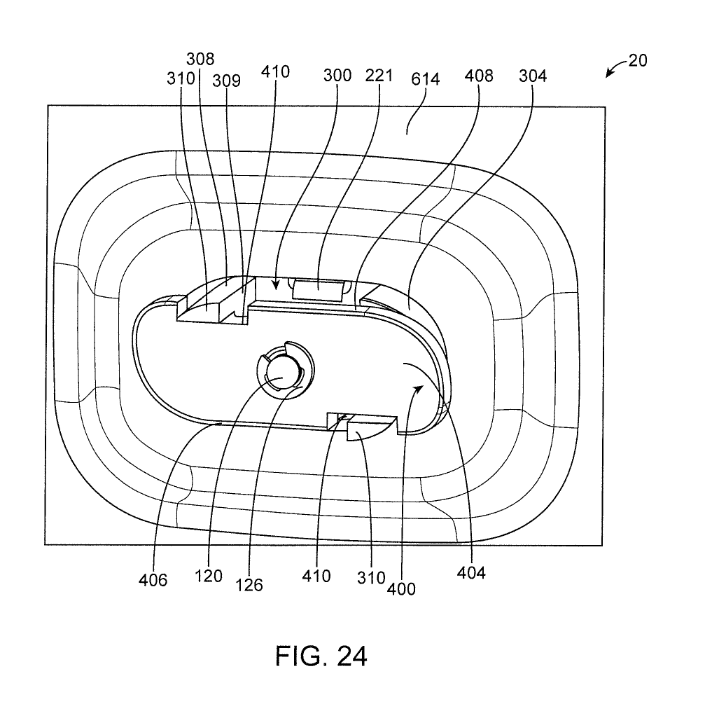

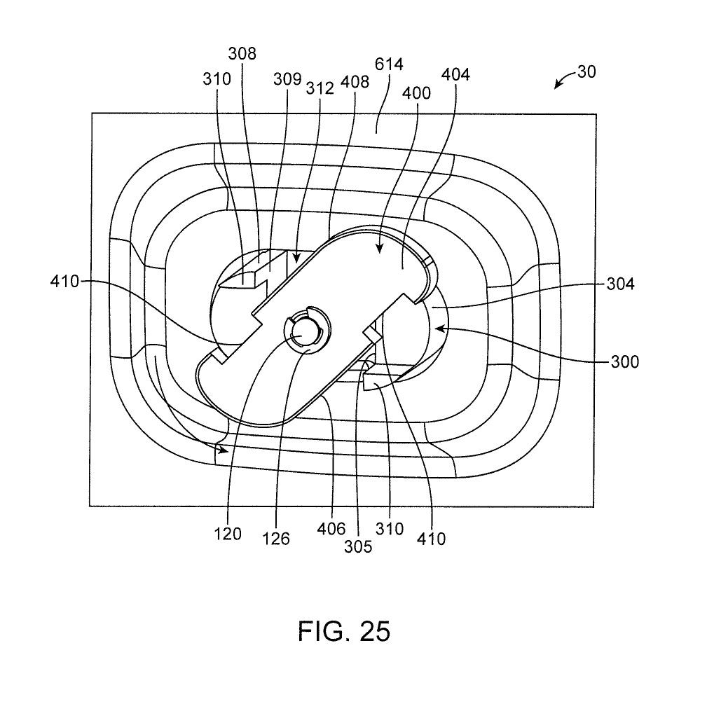

In certain embodiments, shaft 120 can include a through-hole 125 near a distal end 124 of shaft 120. As shown, for example, in FIG. 7, in certain embodiments, a stop member 126 can be disposed within through-hole 125. Stop member can be any suitable material, for example, plastic or metal. In certain embodiments, stop member 126 can be a pin having a first end 127 and a second end 128, as shown in FIG. 7. The pin can be secured within through-hole 125, for example, by friction fit or by an adhesive such that first end 127 and a second end 128 protrude from through hole 125. In certain embodiments, the pin-type stop member 126 can be protrusions extending from shaft 120 that are integrally formed with shaft 120. As shown, for example, in FIG. 3, in certain embodiments, stop member 126 can engage a channel 405 in lock plate 400. This can facilitate rotation of lock plate 400, particularly to initiate rotation of lock plate 400 from the insertion configuration 20 through the transitional configuration 30 (see FIGS. 24 and 25). With stop member 126 initially disposed within channel 405, as eye-bolt 100 is rotated, force is imparted to lock plate 400 to initiate rotation of lock plate 400 as well.

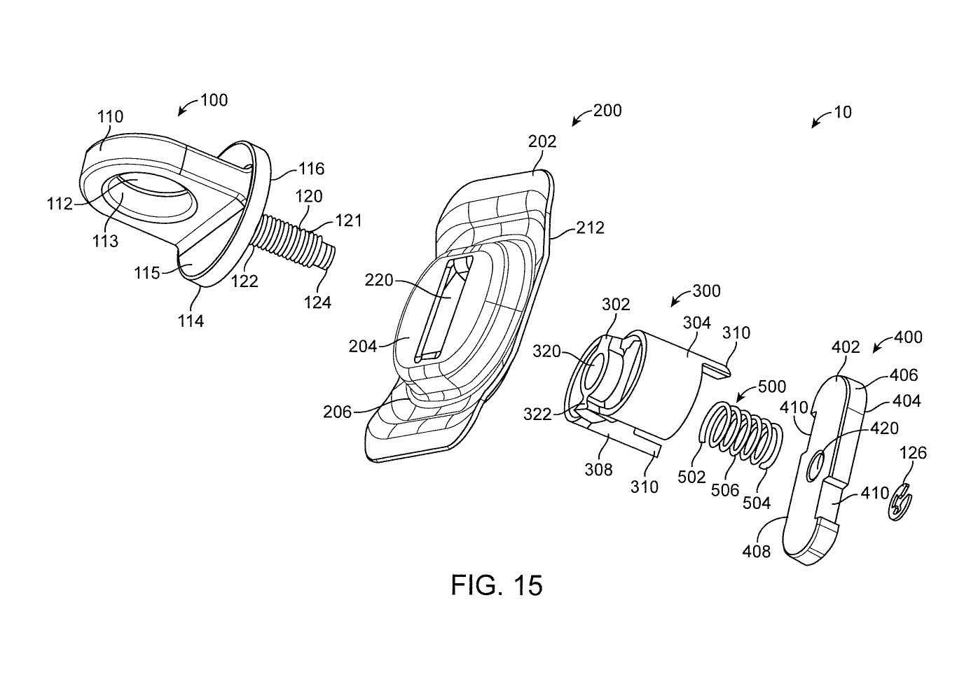

In certain embodiments, stop member 126 can be a “c-clip” as shown, for example, in FIG. 15. In such an embodiment, stop member 126 can be disposed about shaft 120. In certain embodiments, stop member 126 can be a ring disposed about distal end 124 of shaft 120. Other types of stop members can be used, for example, deformed threading, an increased shaft diameter, a washer, or a nylon patch at the distal end 124 of shaft 120.

An advantage of stop member 126 is that is configured to prevent lock plate 400 from detaching off the distal end 124 of shaft 120, for example, when removing tie-down assembly 10 from the wall of a vehicle. Without stop member 126, it would be possible for lock plate 400 to fall off the distal end 124 of shaft 120 as the user unscrews eye-bolt 100 because the user cannot see how far along shaft 120 the lock plate has been displaced when the tie-down assembly 10 is installed in the wall of the vehicle.

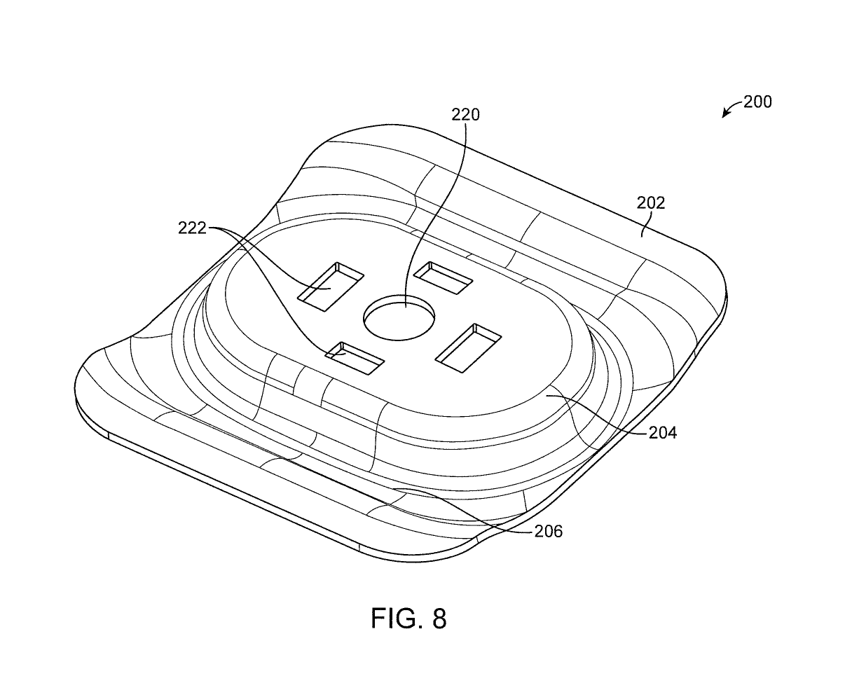

FIG. 8 illustrates face plate 200, according to an embodiment. Face plate can be made of any suitable material, for example, metal. In certain embodiments, face plate 200 can be steel. Generally, face plate 200 should be made of a material strong enough to withstand the load forces placed on face plate 200 by the loads that will be secured to tie-down assembly 10, as face plate 200 acts with lock plate 400 to clamp tie-down assembly 10 to wall 610 of vehicle 600.

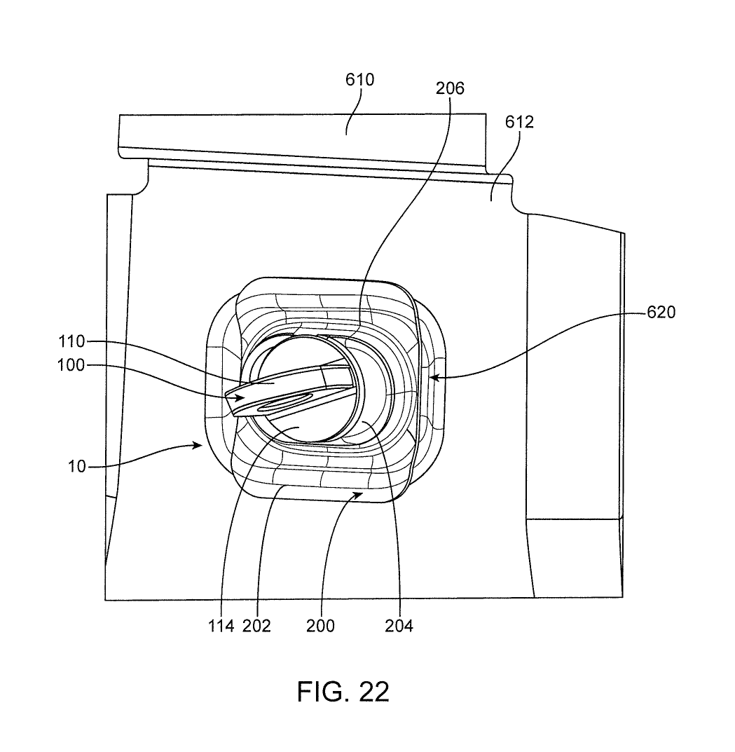

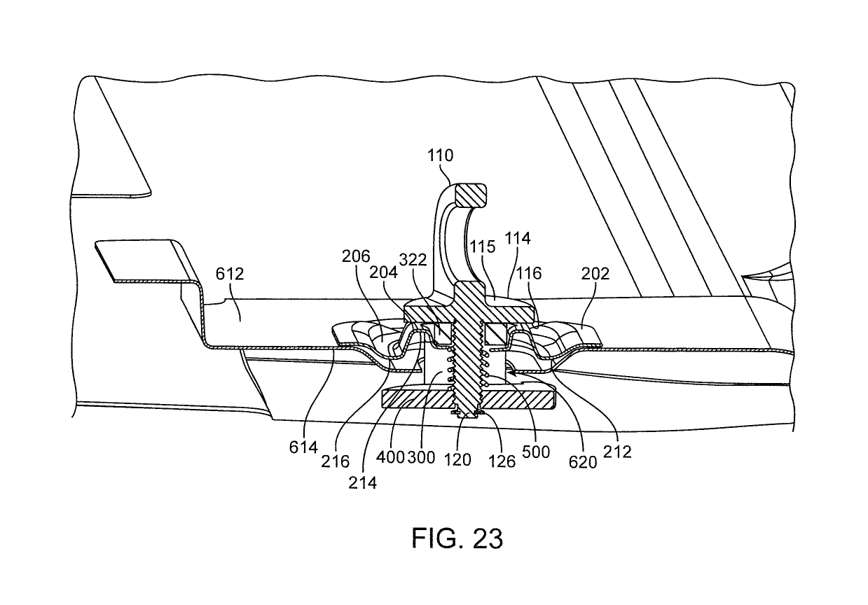

Face plate 200 can include exterior surface 202 and aperture 220. Aperture 220 can be sized and shaped such that shaft 120 of eye-bolt 100 can be disposed therethrough. In certain embodiments, aperture 220 can be disposed in a center of face plate 200. In certain embodiments, aperture 220 can be circular. Exterior surface 202 of face plate 200 can be visible when tie-down assembly 10 is installed in the wall of a vehicle. In certain embodiments, face plate 200 can include a raised portion 204 and trough 206. The curvature of face plate 200 can be configured to correspond to a curvature of a vehicle wall, for example, as shown in FIGS. 22 and 23. This can reduce sliding of tie-down assembly 10 when secured within hole 620 of wall 610.

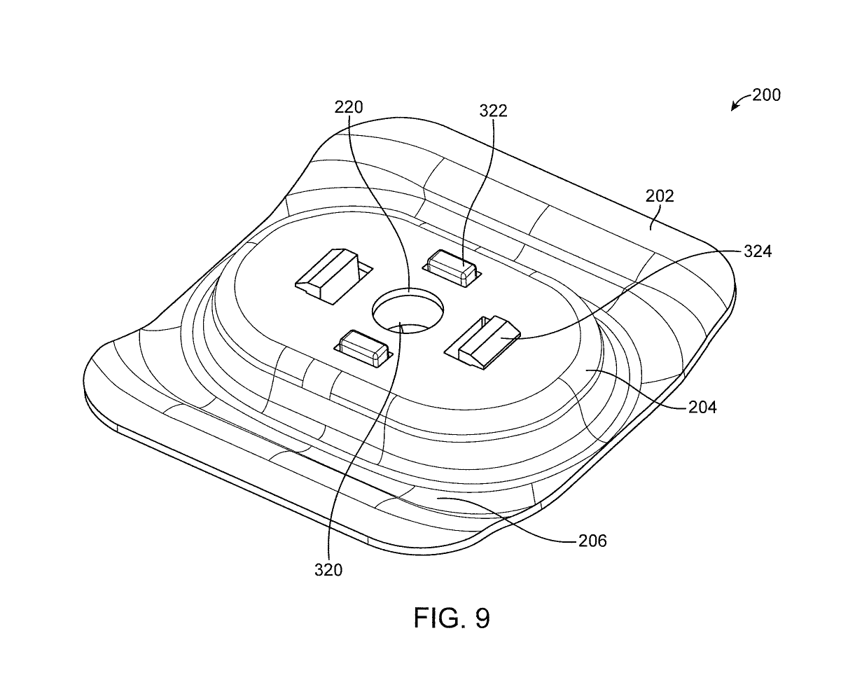

In certain embodiments, face plate 200 can include one or more through-holes 222. As shown, for example in FIG. 9, in certain embodiments, protrusions 322 and/or clips 324 of carrier 300 can extend through the through-holes 222 of face plate 200 to couple carrier 300 with face plate 200. For example, protrusions 322 can provide a friction fit between carrier 300 and face plate 200 and clips 324 can provide a snap-fit between carrier 300 and face plate 200. In certain embodiments, protrusions 322 and/or clips 324 can provide a bearing surface for the interior surface 116 of base 114 of eye-bolt 100 as eye-bolt 100 is rotated. Carrier 300 can be disposed partially within (i.e., under) raised portion 204 of face plate 200. This can serve to further reduce the overall depth of the tie-down assembly 10, enabling it to fit inside a smaller void space of a vehicle wall.

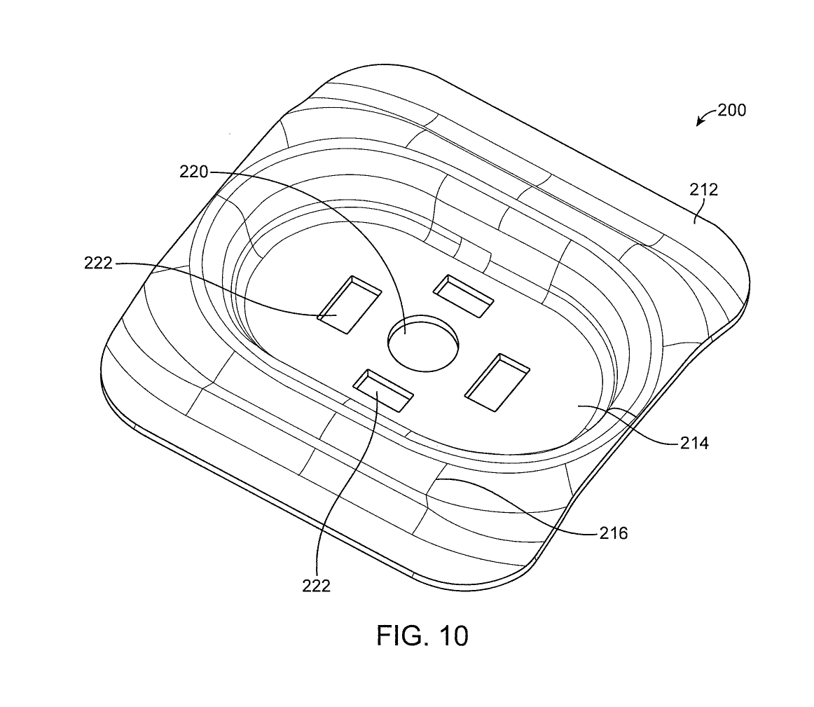

FIG. 10 illustrates a rear perspective view of face plate 200, according to an embodiment. Face plate 200 can include interior surface 212, which can have an indentation 214 corresponding to raised portion 204 of the exterior surface 202. As discussed above, carrier 300 can be disposed partially within indentation 214 of face plate 200. Similarly, interior surface 212 can have a ridge 216 corresponding to trough 206 of the exterior surface 202. As shown, for example in FIG. 22, when tie-down assembly 10 is installed in the wall 610 of a vehicle, face plate 200, and more specifically interior surface 212, can be disposed against a first side 612 of wall 610. In certain embodiments, a curvature of face plate 200 can correspond to a curvature of wall 610, such that face plate 200 is disposed within the curvature of the wall. Interior surface 212 of face plate 200 can contact the wall 610 to help maintain tie-down assembly 10 in place.

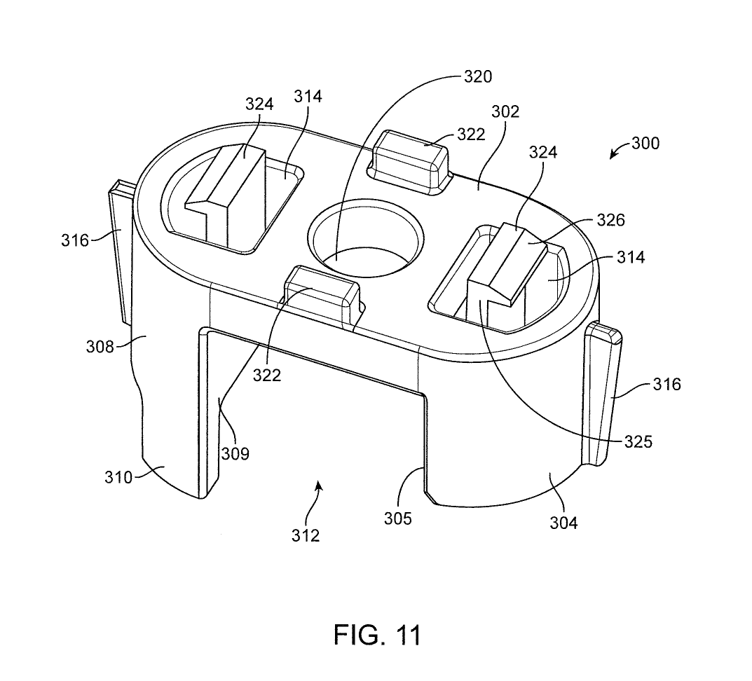

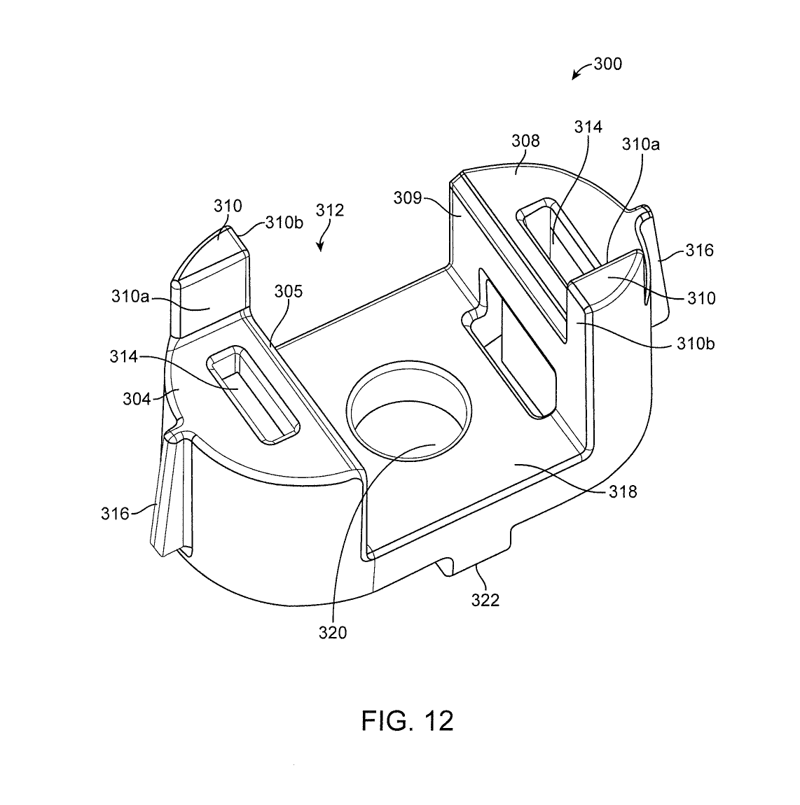

FIGS. 11 and 12 illustrate carrier 300, according to an embodiment. Carrier 300 can be made of any suitable material. In certain embodiments, carrier 300 can be plastic to reduce the overall weight of tie-down assembly 10, since carrier 300 does not bear as much force as face plate 200 or lock plate 400 when securing tie-down assembly 10 to wall 610 of the vehicle 600.

Carrier 300 can be configured to be removably coupled with face plate 200. For example, as described with respect to FIG. 9, carrier 300 can include one or more protrusions 322 and/or one or more clips 324 which can extend through the through-holes 222 of face plate 200 to couple carrier 300 with face plate 200. In certain embodiments, carrier 300 can have two protrusions 322 and two clips 324. In certain embodiments, clips 324 of carrier 300 can include an extension 325 and a flange 326, to physically couple carrier 300 with face plate 200. For example, extension 325 can extend through a through-hole 222 of face plate 200 and flange 326 can engage exterior surface 202 of face plate 200 to couple carrier 300 with face plate 200. In certain embodiments, attachment surface 302 of carrier 300 can contact interior surface 212 of face plate 200, for example, along indentation 214. In certain embodiments, carrier 300 can be sized and shaped to fit within indentation 214 of interior surface 212 of face plate 200. In certain embodiments, carrier 300 can have a generally oval shape. In certain embodiments, carrier 300 can be rectangular with rounded ends.

Carrier 300 can include aperture 320. Aperture 320 can be sized and shaped such that shaft 120 of eye-bolt 100 can extend therethrough. In certain embodiments, aperture 320 can be disposed in a center of carrier 300. In certain embodiments, aperture 320 can be circular.

As shown, for example, in the rear perspective review of FIG. 12, in certain embodiments, carrier 300 can include one or more portions 304, 308 extending from rear surface 318 of carrier 300, referred to herein as first extension portion 304 and a second extension portion 308, respectively. In certain embodiments, the extension portions 304, 308 can be extensions from rear surface 318 of carrier 300, for example, but not limited to posts, columns, protrusions, or flanges. In certain embodiments, extension portions 304, 308 can be semi-circular in shape. In certain embodiments, extension portions 304, 308 can be taller than they are wide. In certain embodiments, extension portions 304, 308 can include a hollow space 314 within an interior of the extension portion. This can reduce the weight of carrier 300.

In certain embodiments, first extension portion 304 and second extension portion 308 can include a first wall 305 and a second wall 309, respectively. In certain embodiments, first wall 305 and second wall 309 can be generally flat. In certain embodiments, first wall 305 and second wall 309 can be parallel to one another. As shown, for example in FIG. 12, first wall 305 and second wall 309 can delineate an empty space or channel 312 between first extension portion 304 and second extension portion 308. When lock plate 400 is rotated from its insertion configuration 20 (see FIG. 24), it can be drawn along shaft 120 of eye-bolt 100 and guided within channel 312. Therefore, channel 312 is slightly wider than a width between first edge 406 and second edge 408 of lock plate 400. In certain embodiments, the width of channel 312 is such that first edge 406 and second edge 408 of lock plate 400 contact and slide along first extension portion 304 and second extension portion 308, respectively, as lock plate 400 moves along shaft 120.

In certain embodiments, one or both extension portions 304, 308 can include a protrusion, referred to herein as a stop tab 310. In certain embodiments, the extension portions 304, 308 can be the stop tabs 310. In certain embodiments, stop tab 310 can be a protrusion extending from a face of extension portions 304, 308. In certain embodiments, stop tab 310 can cover less than half the face of extension portions 304, 308. Stop tabs 310 can inhibit rotation of lock plate 400 beyond a configuration where lock plate 400 is engaged with stop tabs 310. Stop tabs 310 can include respective first surfaces 310a and second surfaces 310b. In certain embodiments, first surface 310a and second surface 310b can be perpendicular. In certain embodiments, second surface 310b can be coplanar with the respective first wall 305 and second wall 309.

In certain embodiments, for example as shown in FIG. 24, in the insertion configuration 20, first portion 406a (or notch 410) of first edge 406 of lock plate 400 can be disposed adjacent to or in contact with first surface 310a of the stop tab 310 of first extension portion 304. Similarly, first portion 408a (or notch 410) of second edge 408 of lock plate 400 can be disposed adjacent to or in contact with first surface 310a of the stop tab 310 of second extension portion 308 in the insertion configuration 20. In certain embodiments, first surfaces 310a can prevent rotation of the lock plate in a clockwise direction. Once lock plate 400 is rotated, respective second portions 406b, 408b of first and second edges 406, 408 can contact respective second surfaces 310b of the stop tabs 310. In certain embodiments, second surfaces 310b can prevent rotation of the lock plate in a counter-clockwise direction. One of skill in the art would understand that the components could also be configured such that first surfaces 310a can prevent rotation of the lock plate in the counter-clockwise direction and second surfaces 310b can prevent rotation of the lock plate in the clockwise direction.

In certain embodiments, carrier 300 can include one or more flange 316 extending from a first extension portion 304 and a second extension portion 308. The flanges 316 can facilitate locating and securing carrier 300 within indentation 214 of interior surface 212 of face plate 200.

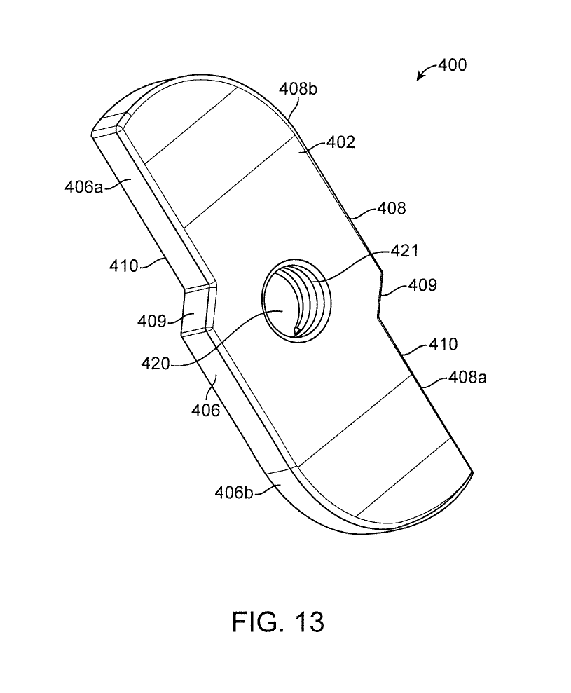

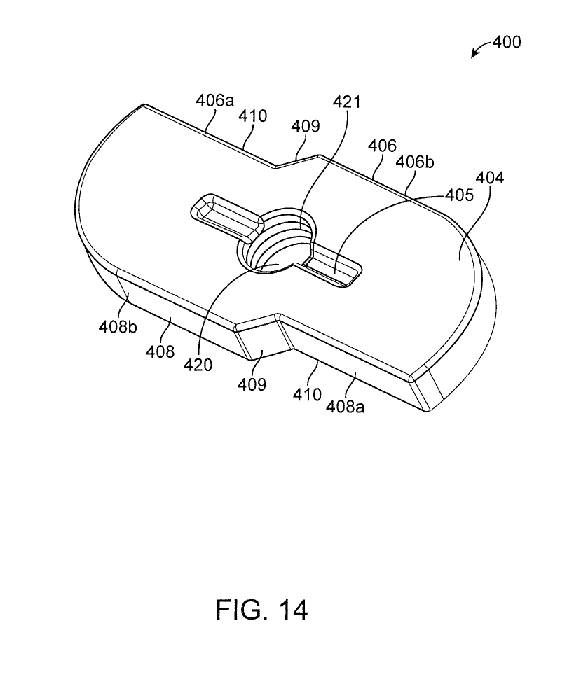

FIGS. 13 and 14 illustrate lock plate 400 according to an embodiment. Lock plate 400 can be made of any suitable material, for example, metal. In certain embodiments, lock plate 400 can be steel.

Lock plate 400 can have a contact surface 402, a first edge 406, and a second edge 408. Lock plate 400 can have an aperture 420. Aperture 420 can be sized and shaped such that shaft 120 of eye-bolt 100 can extend therethrough. In certain embodiments, aperture 420 can be circular. In certain embodiments, aperture 420 can include threading 421 such that shaft 120 of eye-bolt 100 can rotate within the aperture 420 of lock plate 400. Lock plate 400 is the counterpart to face plate 200 that acts to clamp tie-down assembly 10 to wall 610 of vehicle 600. As lock plate 400 is drawn along shaft 120 of eye-bolt 100 within channel 312 of the carrier 300, the wall 610 of vehicle 600 is sandwiched or pinned between the contact surface 402 of lock plate 400 and the interior surface 212 of face plate 200. Eye-bolt 100 can be rotated until tie-down assembly 10 is firmly secured to wall 610.

In certain embodiments, first edge 406 can include first portion 406a, second portion 406b, and angled portion 409 disposed between first portion 406a and second portion 406b. In certain embodiments, second edge 408 can have first portion 408a, second portion 408b, and angled portion 409 disposed therebetween. The angled portions 409 and first portions 406a, 408a can form respective notches 410 in first edge 406 and second edge 408. As discussed above, first portions 406a, 408a of the first and second edges 406, 408 can be configured to engage first surfaces 310a of stop tabs 310 and second portions 406b, 408b of the first and second edges 406, 408 can be configured to engage second surfaces 310b of stop tabs 310. In certain embodiments, a notch 410 of lock plate 400 can be sized and shaped to correspond to stop tab 310 (see, e.g., FIG. 24).

FIG. 14 illustrates a rear perspective view of lock plate 400, according to an embodiment. As shown in FIG. 14, in certain embodiments, a distal surface 404 of lock plate 400 can include a channel 405. Channel 405 can be configured to receive a stop member 126 of shaft 120 of eye-bolt 100. In certain embodiments, the stop member 126 can be disposed within channel 405 of lock plate 400. Rotation of eye-bolt 100 can thus result in rotation of lock plate 400. As lock plate 400 is drawn along shaft 120 of eye-bolt 100 by further rotation of eye-bolt 100, the stop member 126 can disengage from channel 405 of lock plate 400.

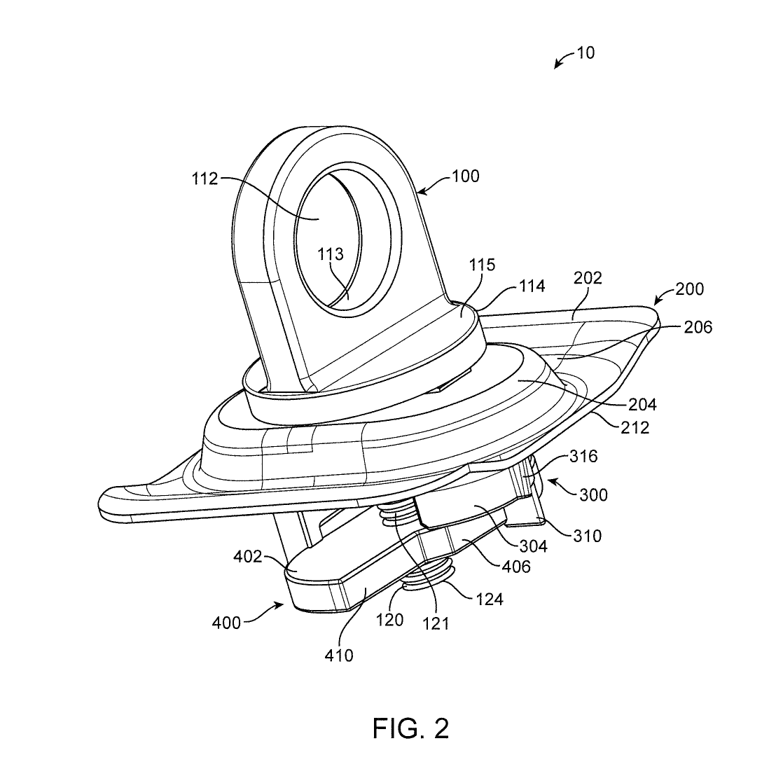

FIGS. 2-5 illustrate components of tie-down assembly 10 in an assembled configuration, according to an embodiment. As shown in FIG. 2, eye-bolt 100 extends through face plate 200, carrier 300, and lock plate 400. This compact configuration allows tie-down assembly 10 to fit within a small interior void space of a vehicle wall. The carrier 300, lock plate 400, and shaft 120 of eye-bolt 100 can be inserted through a hole in the vehicle wall such that interior surface 212 of face plate 200 contacts first side 612 of the wall 610 (see, e.g., FIG. 22). The distal end 124 of the shaft 120, the lock plate 400, and at least a portion of carrier 300 are disposed on an opposite of the wall, within the interior void space of the wall 610 (see, e.g., FIG. 23).

FIG. 3 illustrates tie-down assembly 10, according to an embodiment, from a rear perspective view. FIG. 3 illustrates tie-down assembly 10 after rotating eye-bolt 100 such that lock plate 400 has rotated approximately 90 degrees counter-clockwise (as viewed from the rear) from the insertion configuration 20 (see FIG. 24). Stop member 126, which can be disposed within channel 405 of lock plate 400, can facilitate this rotation. First edge 406 and second edge 408 then engage stop tabs 310 of first extension portion 304 and second extension portion 308, respectively, which prevents further counter-clockwise rotation of lock plate 400. As eye-bolt 100 is rotated further (in a clockwise direction as viewed from the front, for example, as shown in FIG. 2), lock plate 400 is drawn along threading 121 of shaft 120 in a direction toward rear surface 318 of carrier 300 within the channel 312 between first extension portion 304 and second extension portion 308.

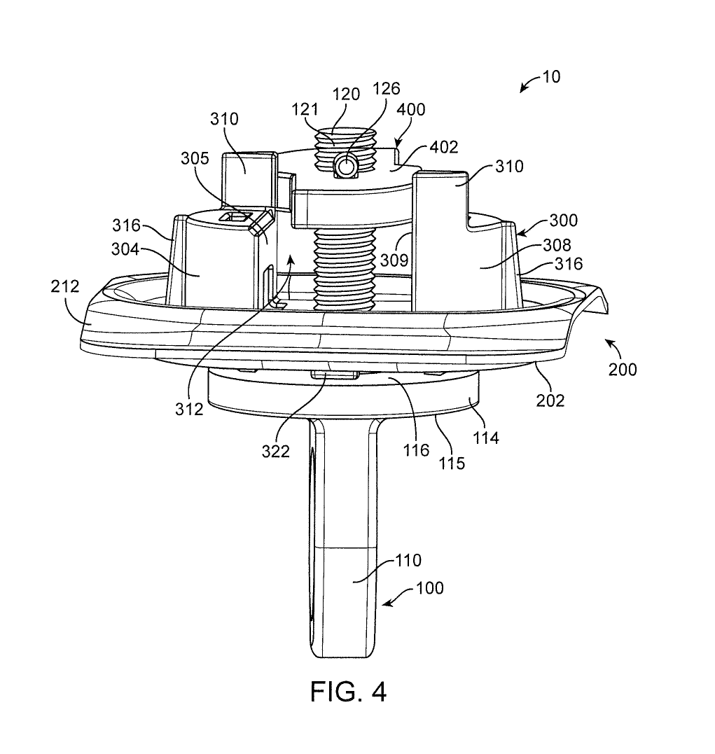

FIG. 4 illustrates a side perspective view of tie-down assembly 10, according to an embodiment. As eye-bolt 100 is rotated, lock plate 400 will be drawn toward face plate 200 along the shaft 120 of eye-bolt 100. Lock plate 400 can be guided toward face plate 200 within the channel 312 between first extension portion 304 and second extension portion 308 of carrier 300. The lock plate 400 can be drawn toward face plate 200 until the wall 610 of the vehicle is pinned between contact surface 402 of lock plate 400 and interior surface 212 of face plate 200.

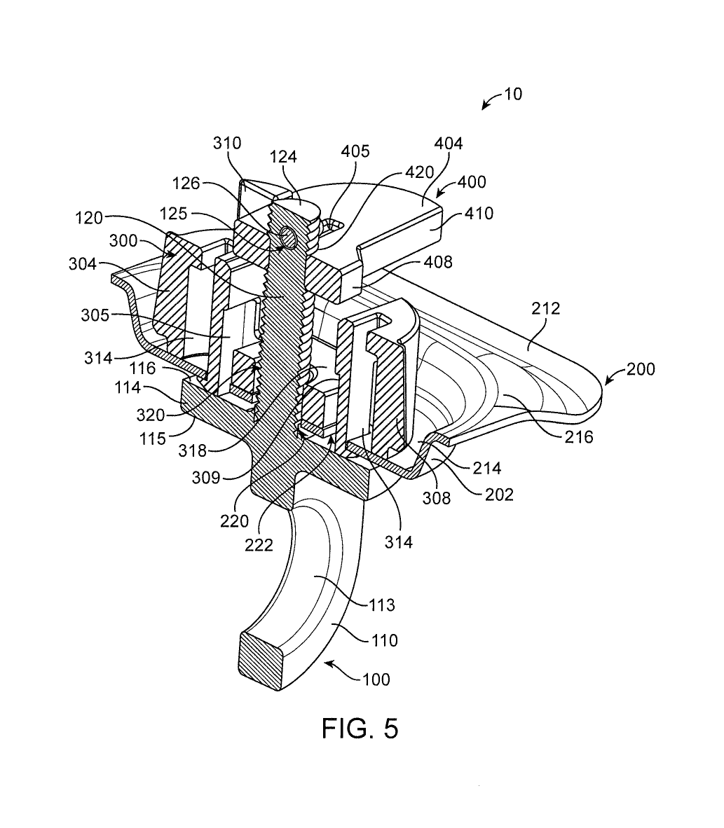

FIG. 5 illustrates a cross-sectional view of tie-down assembly 10, according to an embodiment. As shown in FIG. 5, shaft 120 of eye-bolt 100 can extend through face plate 200, carrier 300, and lock plate 400. The stop member 126 can extend through a though-hole 125 of shaft 120 of eye-bolt 100. In certain embodiments, first extension portion 304 and/or second extension portion 308 can have a hollow space 314 within an interior of the respective extension portion.

FIGS. 15-19 illustrate tie-down assembly 10, according an embodiments. Many of the features of tie-down assembly 10 of the embodiment in FIG. 15 are the same or similar to those in the embodiment of tie-down assembly 10 in FIG. 1. As shown in FIG. 15, the primary components of tie-down assembly 10 are eye-bolt 100, face plate 200, carrier 300, and lock plate 400.

In certain embodiments, tie-down assembly 10 can include spring 500. In certain embodiments, spring 500 can be disposed between carrier 300 and lock plate 400. A first end 502 of spring 500 can engage carrier 300 and a second end 504 of spring 500 can engage lock plate 400. Spring 500 can provide pressure against lock plate 400 to facilitate unfastening tie-down assembly 10. For example, spring 500 can impart a force onto lock plate 400 to facilitate movement of lock plate 400 from within channel 312 of carrier 300 as lock plate 400 moves toward distal end 124 of shaft 120 when rotating eye-bolt 100 in a direction opposite to the fastening direction.

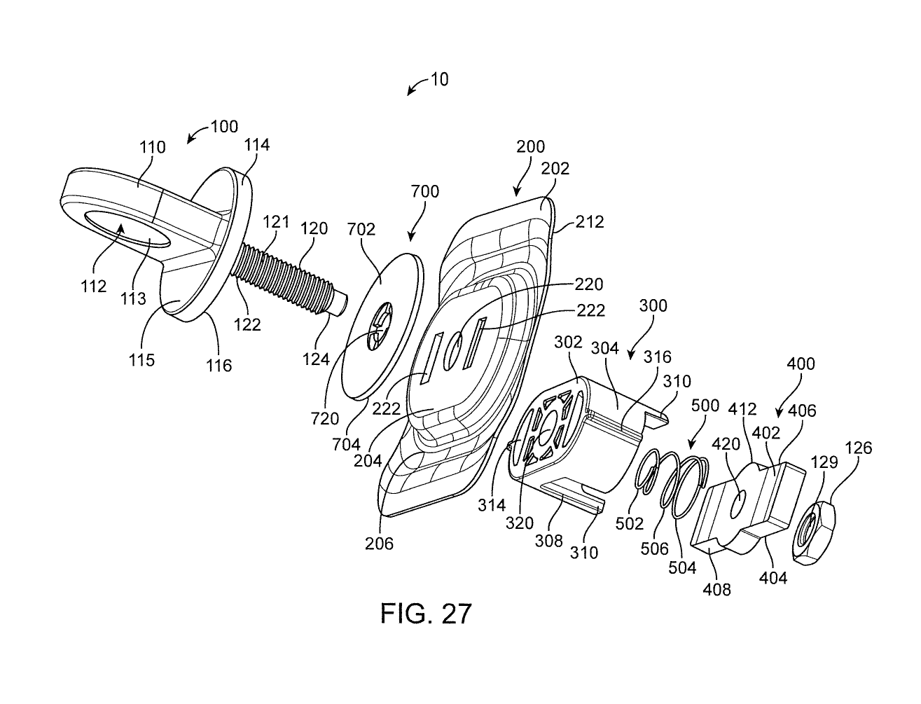

Spring 500 can have a plurality of coils 506. In certain embodiments, spring 500 can be a conical spring, where a first end 502 of spring 500 has a smaller diameter than a second end 504, or vice versa, as illustrated for example in FIG. 27.

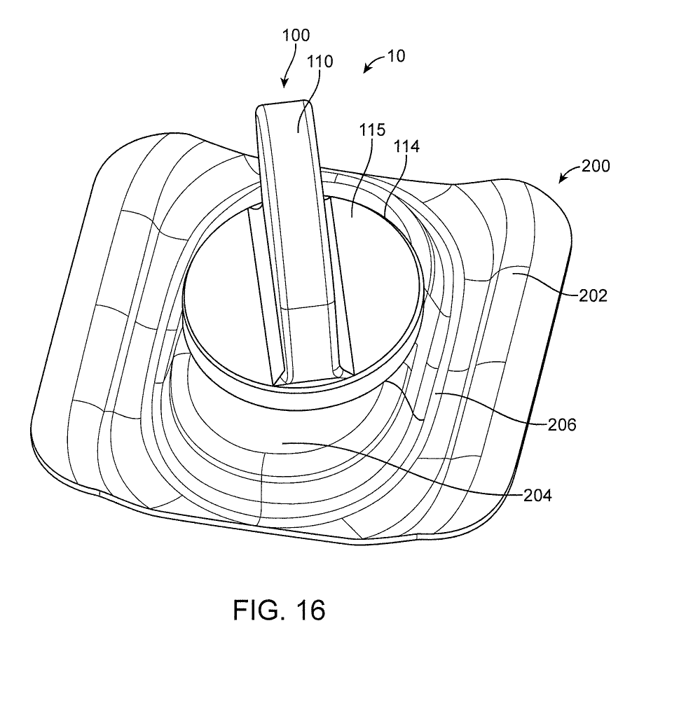

FIG. 16 illustrates eye-bolt 100 assembled with face plate 200, according to an embodiment. Base 114 of eye-bolt 100 can engage exterior surface 202 of face plate 200, for example, at a raised portion 204 of face plate 200. As shown in FIG. 15, in certain embodiments, aperture 220 in face plate 200 can be an elongated slot.

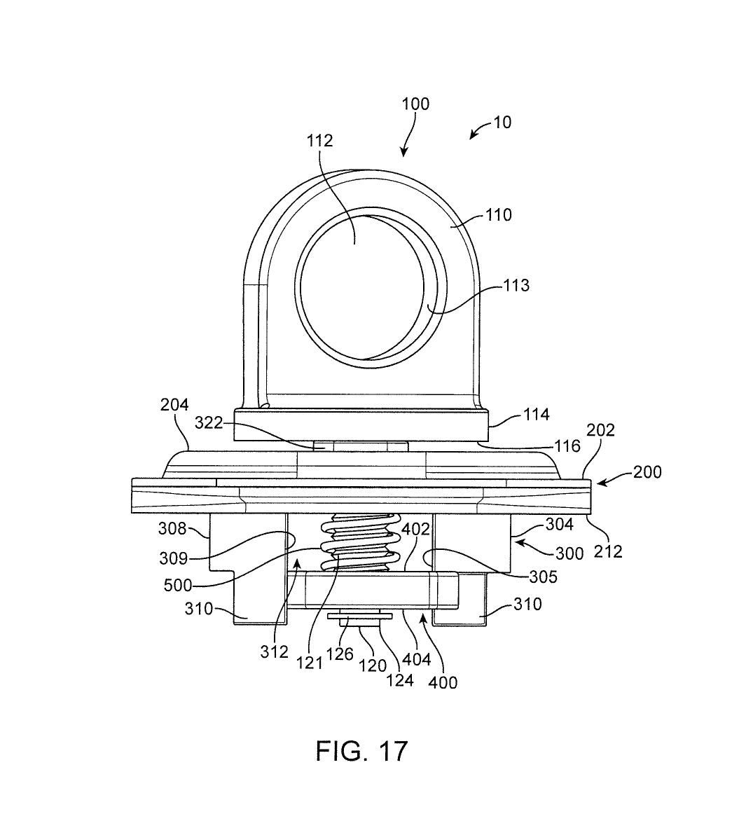

FIG. 17 illustrates a side view of tie-down assembly 10 in an assembled configuration, according to an embodiment. As shown in FIG. 17, coils 506 of spring 500 can be disposed about threading 121 of shaft 120 of eye-bolt 100. In the embodiments shown in FIGS. 15-19, stop member 126 is a “c-clip” disposed about and coupled to a distal end 124 of the shaft 120 of eye-bolt 100. Much like the pin shown in FIG. 1, the “c-clip” can prevent lock plate 400 from disengaging off the distal end 124 of shaft 120. As also shown in FIG. 17, protrusions 322 of carrier 300 can provide a bearing surface for interior surface 116 of base 114 of eye-bolt 100.

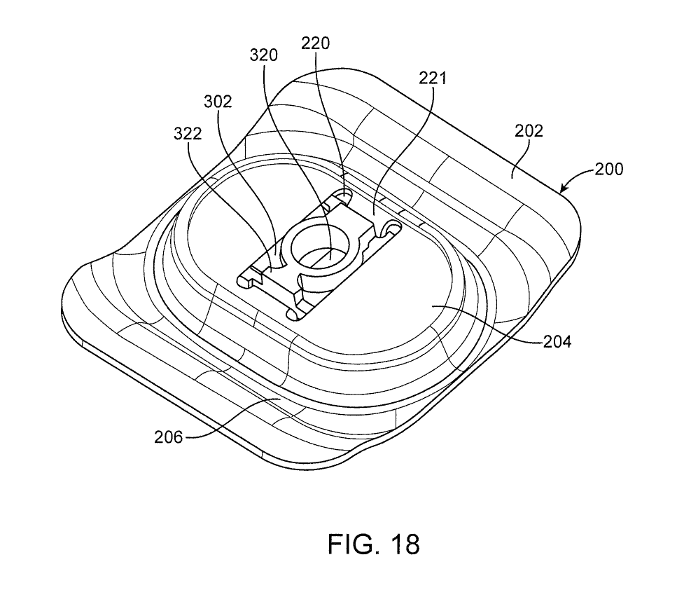

FIG. 18 illustrates face plate 200 coupled with carrier 300, according to an embodiment. In certain embodiments, aperture 220 of face plate 200 can be a slot through face plate 200. In certain embodiments, a protrusion 322 from attachment surface 302 of carrier 300 can be configured to fit within the slot aperture 220 of face plate 200. In certain embodiments, face plate 200 can include one or more flange 221, which can engage attachment surface 302 of carrier 300 to couple carrier 300 with face plate 200.

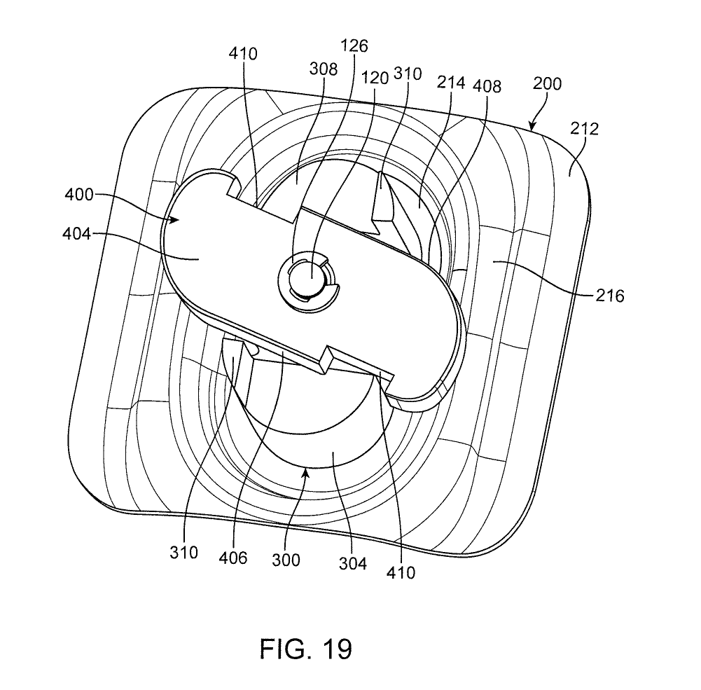

FIG. 19 illustrates a rear perspective view of tie-down assembly 10, according to an embodiment. As shown in FIG. 19, stop member 126 can be disposed about shaft 120, thereby preventing lock plate 400 from unthreading off the distal end 124 of shaft 120. In certain embodiments, first edge 406 and/or second edge 408 of lock plate 400 can include a notch 410. In certain embodiments, notch 410 can be sized and shaped to correspond to a shape of stop tabs 310 of first extension portion 304 and second extension portion 308. As such, when lock plate 400 is disposed in an insertion configuration 20, as shown for example in FIG. 24, stop tabs 310 can be disposed within notches 410 of lock plate 400. As lock plate 400 is rotated due to its coupling to shaft 120 of eye-bolt 100, first edge 406 and second edge 408 can engage stop tabs 310 of carrier 300. This can prevent rotation of lock plate 400 beyond stop tabs 310.

FIG. 20 illustrates a portion of a vehicle 600 having a tie-down assembly 10 attached thereto, according to an embodiment. More specifically, tie-down assembly 10 can be attached to a wall 610 of vehicle 600. For example, tie-down assembly 10 can be attached to a wall 610 of a vehicle in the bed of a truck. As shown in FIGS. 21 and 22, face plate 200 and head 110 of eye-bolt 100 are exposed an accessible to the user when tie-down assembly 10 is secured to wall 610. Therefore, tie-down assembly 10 provides a location to attach ropes, straps, hooks, bungee cords, etc. As discussed above, other locations for tie-down assembly 10 are contemplated. Tie-down assembly 10 can be disposed anywhere along first side 612 of wall 610. Tie-down assembly 10 can also be disposed on an exterior surface of vehicle 600, for example, an exterior of a side panel or the tailgate. In certain embodiments, tie-down assembly 10 can be disposed above a wheel well 616 of wall 610. Wall 610 can have multiple holes 620, so that more than one tie-down assembly 10 can be used or so that the location of tie-down assembly 10 can be changed.

FIG. 22 shows a close up view of tie-down assembly 10 attached to wall 610, according to an embodiment. As shown in FIG. 22, tie-down assembly 10 can be disposed in a hole 620 in wall 610. In certain embodiments, face plate 200 can contact the first side 612 of wall 610. In certain embodiments, face plate 200 can have a curvature configured to match a curvature of hole 620 in wall 610. When attached to wall 610, head 110 of eye-bolt 100 is accessible to the user. As shown in FIGS. 24-26, for example, the user can rotate head 110 of eye-bolt 100 to secure tie-down assembly 10 onto wall 610.

FIG. 23 illustrates a cross sectional view of tie-down assembly 10 inserted through wall 610, according to an embodiment. Carrier 300 and lock plate 400 can be inserted through hole 620 of wall 610. The distal end 124 of shaft 120, the lock plate 400, and at least a portion of carrier 300 are disposed within the interior void space of wall 610 between the interior and exterior panels of the wall 610. As shown in FIG. 23, interior surface 212 of face plate 200 can contact first side 612 of the interior panel of wall 610. As eye-bolt 100 is rotated, lock plate 400 can be drawn toward proximal end 122 of shaft 120 and thus toward second side 614 of wall 610. Upon further rotation, contact surface 402 of lock plate 400 can engage second side 614 of wall 610, thereby securing tie-down assembly 10 to wall 610 by the forces imparted from face plate 200 onto first side 612 of wall 610 and by lock plate 400 onto second side 614 of wall 610, pinning wall 610 between face plate 200 and lock plate 400.

FIGS. 24-26 illustrate insertion and securement of tie-down assembly 10, according to embodiments, from a rear perspective view (i.e., from the interior of the void space in wall 610). FIG. 24 illustrates an insertion configuration 20, according to an embodiment. Lock plate 400 can be disposed such that the perimeter profiles of lock plate 400 and carrier 300 are generally aligned. This reduces the area of the hole 620 in wall 610 needed to insert the tie-down assembly 10. In certain embodiments, stop tabs 310 can be disposed within notches 410. If lock plate 400 is rotated in the clockwise direction (as viewed from the rear in FIG. 24), stop member 126 will prevent lock plate 400 from unthreading off the distal end 124 of shaft 120.

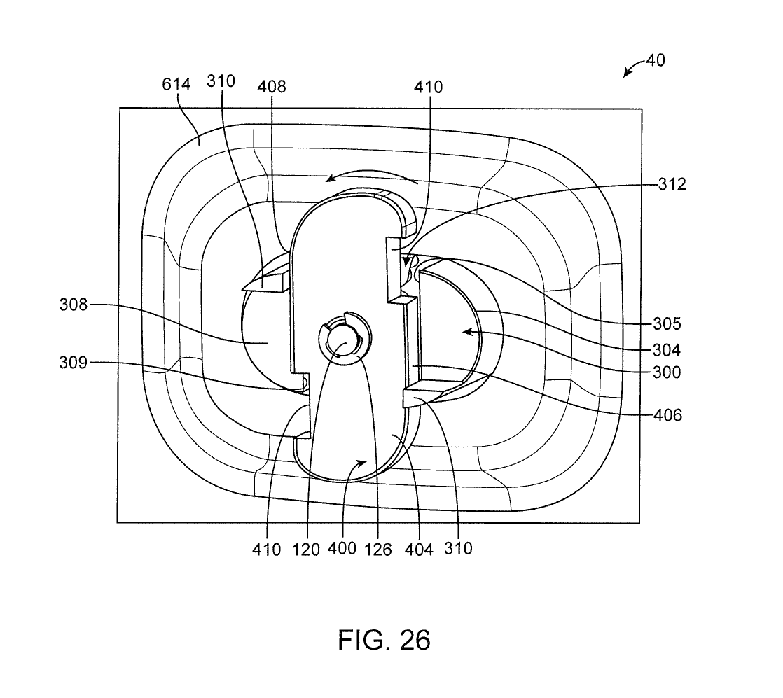

As shown in FIG. 25, as eye-bolt 100 is rotated, for example, in a clock-wise direction, lock plate 400 can rotate in a counter-clockwise direction, from the insertion configuration 20 shown in FIG. 24, to the transitional configuration 30 shown in FIG. 25. As the user continues to rotate eye-bolt 100, lock plate 400 can continue to rotate until it engages stop tabs 310 of carrier 300, as shown in FIG. 26. In certain embodiments, lock plate 400 can rotate 90° before engaging stop tabs 310. In certain embodiments, first edge 406 and second edge 408 of lock plate 400 can engage stop tabs 310. Because lock plate 400 cannot rotate any further in the counter-clockwise direction, lock plate 400 is then drawn along shaft 120 of eye-bolt 100 toward the proximal end 122 of shaft 120. The user can rotate eye-bolt 100 until lock plate 400 engages second side 614 of wall 610, thereby securing tie-down assembly 10 to wall 610 in secured configuration 40.

FIGS. 27 through 32 illustrate a tie-down assembly 10 and elements of the tie-down assembly, according to embodiments. Many of the features are the same or similar to those described above, for example, with respect to FIGS. 1 through 19, with like reference numerals used to indicate identical or functionally similar elements. Operation is the same or similar as described, for example, with respect to FIGS. 20 through 26.

FIG. 27 illustrates an exploded view of a tie-down assembly 10, according to an embodiment. Tie-down assembly 10 can include eye-bolt 100, face plate 200, carrier 300, and lock plate 400.

In certain embodiments, tie-down assembly 10 can include washer 700. Washer 700 can be disposed between eye-bolt 100 and face plate 200 to provide a bearing surface when rotating eye-bolt 100. For example, washer 700 can have an upper surface 702 configured to engage interior surface 116 of base 114 of eye-bolt 100. A lower surface 704 of washer 700 can be configured to engage exterior surface 202 of face plate 200. For example, lower surface 704 can contact raised portion 204 of face plate 200. Washer 700 can include an aperture 720 having a size and shape configured such that shaft 120 of eye-bolt 100 can be disposed therethrough. In certain embodiments, washer 700 and/or aperture 720 can be circular. In certain embodiments, washer 700 can have an outer diameter equal to an outer diameter of the base 114 of eye-bolt 100. Washer 700 can be made of any suitable material, for example, plastic or metal.

In certain embodiments, tie-down assembly 10 can include spring 500. In certain embodiments, spring 500 can be disposed between carrier 300 and lock plate 400, as discussed above with respect to FIG. 15. A first end 502 of spring 500 can engage carrier 300 and a second end 504 of spring 500 can engage lock plate 400. Spring 500 can provide pressure against lock plate 400 to facilitate unfastening tie-down assembly 10, for example, imparting a force onto lock plate 400 to facilitate movement of lock plate 400 from within channel 312 of carrier 300 as lock plate 400 moves toward distal end 124 of shaft 120 when rotating eye-bolt 100 in a direction opposite to the fastening direction. Spring 500 can have a plurality of coils 506. In certain embodiments, spring 500 can be a conical spring, where a first end 502 of spring 500 has a smaller diameter than a second end 504, or vice versa. This can allow spring 500 to deform to a smaller compressed height because the coils 506 will not stack on top of each other when the spring 500 is compressed. Instead, the coils 506 form concentric rings when fully compressed.

In certain embodiments, tie-down assembly 10 can include stop member 126. Stop member 126 can prevent disassembly of lock plate 400 from shaft 120 of eye-bolt 100. As shown in FIG. 27, in certain embodiments, stop member 126 can be a nut having an aperture 129 sized to receive shaft 120. The nut can be threaded or unthreaded. In certain embodiments, the nut can be secured on shaft 120 by an adhesive, for example, but not limited to epoxy, glue, resin, etc. In certain embodiments, the nut can be threaded onto distal end 124 of shaft 120, with or with an adhesive. In certain embodiments, the nut can be disposed about an unthreaded portion of distal end 124 of shaft 120 and secured in place by friction fit or an adhesive.

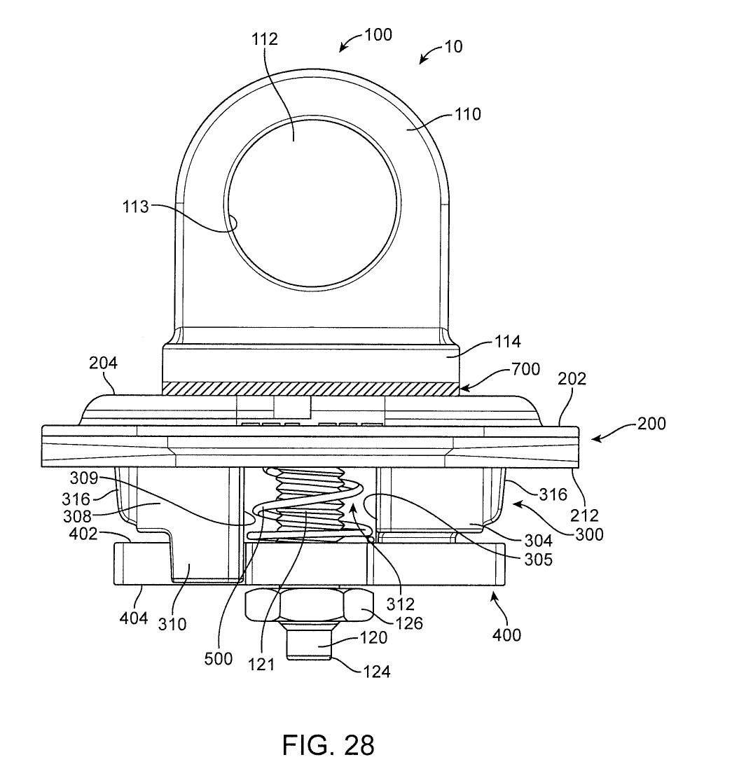

FIG. 28 illustrates a side view of tie-down assembly 10, according to an embodiment. Washer 700 forms a bearing surface between base 114 of eye-bolt 100 and exterior surface 202 of face plate 200. Stop member 126, in this embodiment a nut, is threaded about the distal end 124 of shaft 120. When lock plate 400 is rotated 90 degrees from the insertion configuration shown in FIG. 28, for example, by turning eye-bolt 100, it can be drawn toward proximal end 122 of shaft 120 within channel 312 of carrier 300. This can compress spring 500, which is shown disposed between rear surface 318 of carrier 300 and contact surface 402 of lock plate 400.

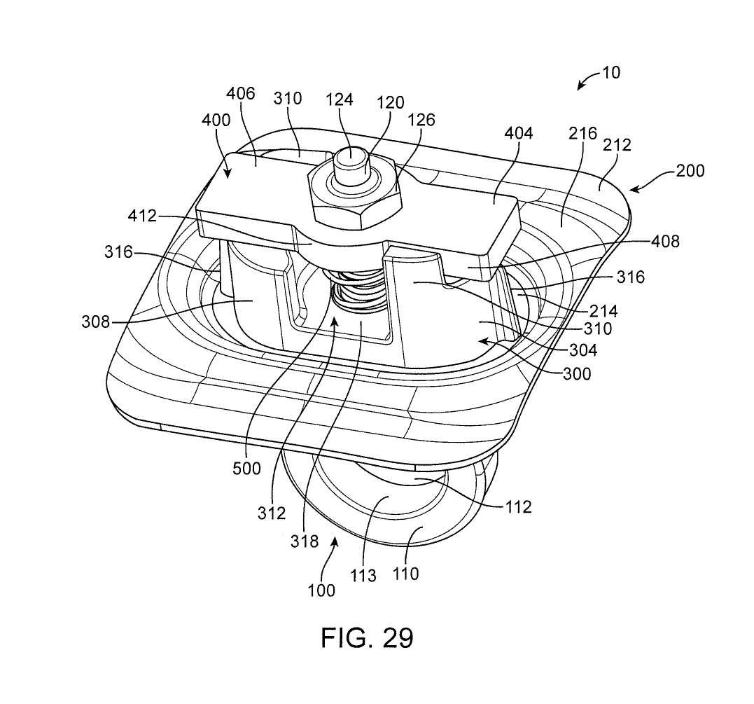

FIG. 29 illustrates a rear perspective view of tie-down assembly 10, according to an embodiment. In FIG. 29, tie-down assembly 10 is in an insertion configuration. In certain embodiments, in the insertion configuration, first edge 406 and second edge 408 can contact stop tabs 310 of carrier 300. Stop tabs 310 can prevent rotation of lock plate 400 in the clockwise direction as viewed in FIG. 29. In certain embodiments, lock plate 400 can have a shape as illustrated in FIG. 29. For example, lock plate 400 can be generally rectangular. In certain embodiments, lock plate 400 can include curved region 412 along first edge 406 and/or second edge 408. Curved region 412 can be disposed at a location corresponding to the aperture 420 through lock plate 400.

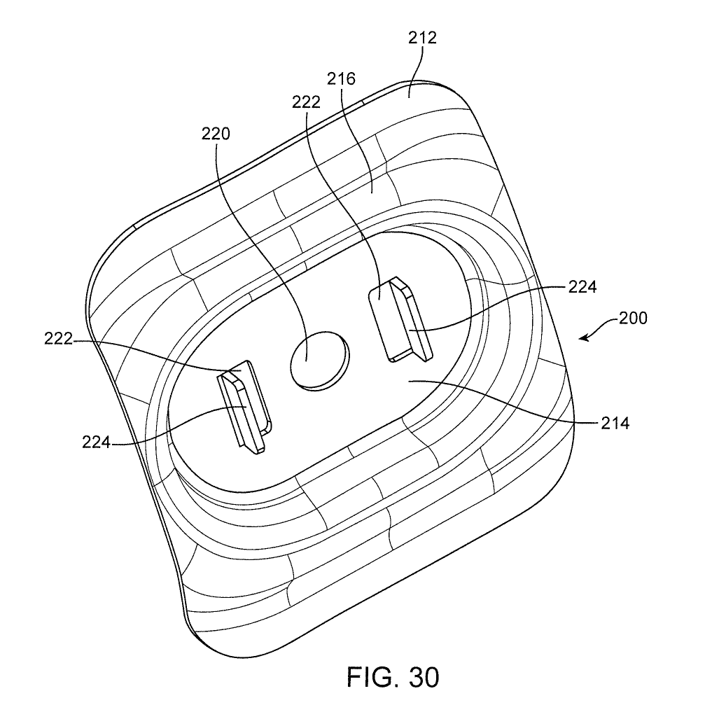

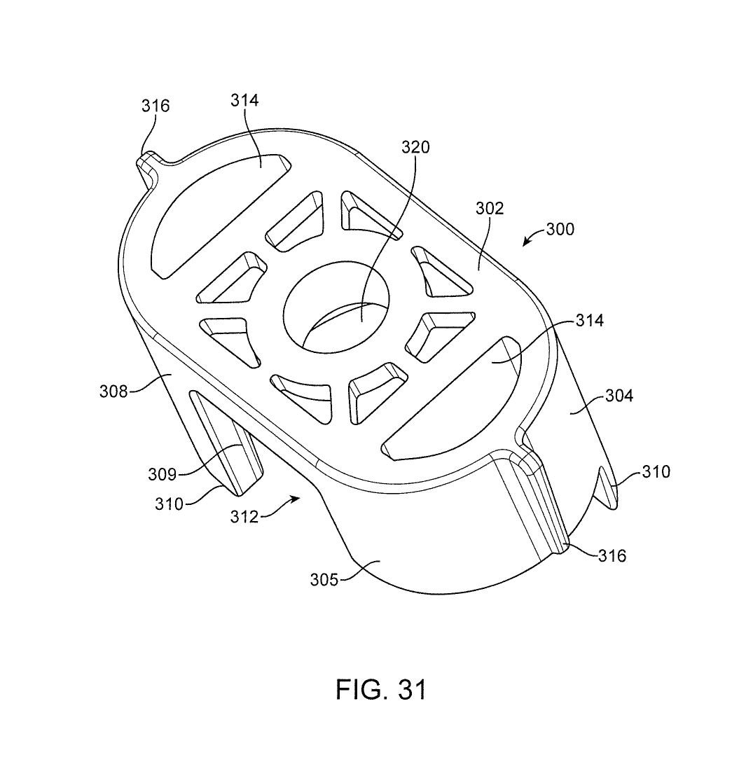

FIG. 30 illustrates a rear perspective view of face plate 200, according to an embodiment. In certain embodiments, face plate 200 can include aperture 220 and one or more flanges 224 extending from interior surface 212. In certain embodiments, flanges 224 can be disposed adjacent to one or more through-holes 222. Flanges 224 can facilitate coupling face plate 200 with carrier 300. For example, flanges 224 can be configured to be disposed within corresponding hollow spaces 314 in attachment surface 302 of carrier 300, which are shown, for example, in FIG. 31.

FIG. 31 illustrates a perspective view of carrier 300, according to an embodiment. Carrier 300 can have many of the same elements described above, for example, with respect to FIGS. 11 and 12. For example, carrier 300 can include attachment surface 302 having one or more hollow spaces 314, first and second extension portions 304, 308, having a channel 312 therebetween, stop tabs 310, and one or more flanges 316.

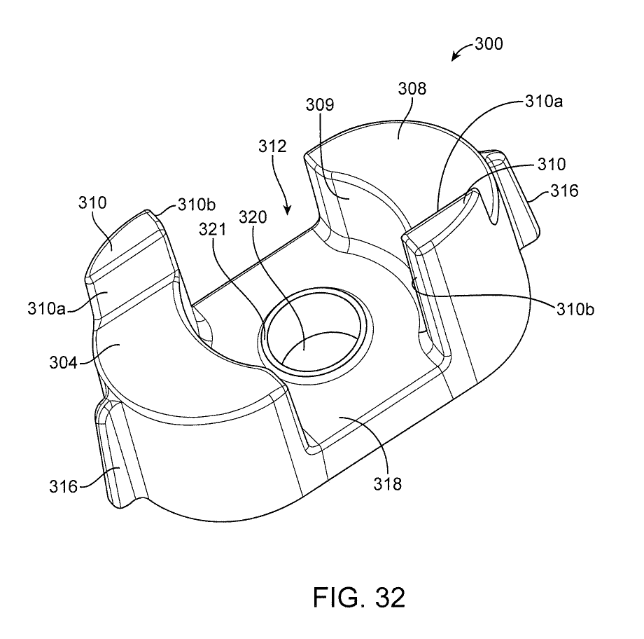

FIG. 32 illustrates a rear perspective view of carrier 300, according to an embodiment. In certain embodiments, stop tabs 310 can be protrusions extending from extension portions 304, 308. In certain embodiments, stop tabs 310 can include respective first surfaces 310a and second surfaces 310b, which can be flat or curved. In certain embodiments, carrier 300 can include first wall 305 and second wall 309. In certain embodiments first and second wall 305, 309 can be curved. For example, first and second wall 305, 309 can correspond to a curvature of curved portion 412 of lock plate 400. First and second walls 305, 309 can form a channel 312 therebetween. In certain embodiments, aperture 320 can include a rim 321 extending from rear surface 318 of carrier 300.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill and art, readily modify and/or adapt for various applications such specific embodiments, without undue experimentation, without departing from general concept of the present embodiments. Therefore, such adaptation and modifications are intended to be within the meaning and range of equivalents of the disclosed embodiments, based on the teaching and guidance presented therein. It is to be understood that phraseology or terminology herein is for the purpose of description and not of limitation, such that the terminology or phraseology of the present specification is to be interrupted by the skilled artisan in light of the teachings and guidance.

The breath and scope of the present disclosure should not be limited by any of the above described exemplary embodiments but should be defined only in accordance with the following claims and their equivalents.

What is claimed is:

1. A tie-down assembly for a vehicle, comprising:
a bolt comprising a head and a shaft;
a face plate comprising an aperture configured to receive the bolt therethrough;
a carrier comprising:
an attachment surface configured to engage the face plate, and
a first stop tab; and
a lock plate configured to be disposed about the bolt comprising:
an aperture configured to receive the bolt therethrough, and
a first edge configured to engage the first stop tab, thereby preventing rotational movement of the lock plate in a first direction.

2. The tie-down assembly of claim 1, wherein the bolt is an eye-bolt and the head comprises an aperture.

3. The tie-down assembly of claim 1, wherein the head of the bolt further comprises a base having an interior surface configured to face the face plate.

4. The tie-down assembly of claim 1, wherein the shaft of the bolt is threaded, the aperture of the lock plate is threaded, and the shaft of the bolt is configured to rotate within the aperture of the lock plate.

5. The tie-down assembly of claim 4, wherein the bolt is configured to rotate within the aperture of the lock plate when the first edge of the lock plate is engaged with the first stop tab.

6. The tie-down assembly of claim 1, wherein the bolt further comprises a stop member at a distal end of the shaft.

7. The tie-down assembly of claim 6, wherein the stop member comprises a nut disposed around the distal end of the shaft.

8. The tie-down assembly of claim 1, further comprising a spring disposed about the shaft between the carrier and the lock plate.

9. The tie-down assembly of claim 1, wherein the face plate further comprises an exterior surface having a raised portion and an interior surface having a corresponding indentation, and wherein the carrier is configured to be disposed within the indentation of the interior surface.

10. The tie-down assembly of claim 1, wherein the carrier further comprises a second stop tab, and wherein a second edge of the lock plate is configured to engage the second stop tab, thereby preventing rotational movement of the lock plate in the first direction.

11. The tie-down assembly of claim 1, wherein the carrier further comprises one or more protrusions extending from the attachment surface and configured to mate with one or more corresponding through-holes in the face plate to releasably couple the carrier with the face plate.

12. The tie-down assembly of claim 1, wherein the first edge of the lock plate comprises a first notch, wherein the first notch is configured to engage the first stop tab, thereby preventing rotational movement of the lock plate in a second direction.

13. The tie-down assembly of claim 12, wherein the second edge of the lock plate comprises second a notch, wherein the second notch is configured to engage the second stop tab, thereby preventing rotational movement of the lock plate in the second direction.

14. The tie-down assembly of claim 1, wherein the face plate is configured to contact an exposed surface of a wall of the vehicle, and wherein the lock plate and at least a portion of the carrier are configured to be disposed in a void space of the wall of the vehicle.

15. An anchoring system, comprising:
a bolt comprising:
a head having an aperture, and
a threaded shaft;
a face plate comprising an aperture configured to receive the shaft therethrough, wherein the face plate is configured to contact a first side of a wall;
a carrier coupled to the face plate comprising:
a first stop tab,
wherein at least a portion of the carrier is configured to be disposed on a second side of the wall; and
a lock plate comprising:
an aperture having threading, wherein the bolt is configured to rotate within the aperture of the lock plate, and
a first edge configured to engage the first stop tab upon rotation of the bolt in a first direction, thereby preventing rotational movement of the lock plate in the first direction,
wherein the lock plate is configured to be disposed on the second side of the wall.

16. The anchoring system of claim 15, wherein the wall is a wall of a vehicle.

17. The anchoring system of claim 15, wherein rotation of the bolt in the first direction moves the lock plate along the shaft of the bolt in a direction toward the face plate.

18. The anchoring system of claim 15, wherein the lock plate engages the first stop tab at 90 degrees of rotation from an insertion configuration.

19. The anchoring system of claim 15, wherein the lock plate is disposed in a first configuration during insertion through an aperture in the wall, and wherein the lock plate is disposed in a second position upon rotation in the first direction such that the lock plate engages the first stop tab.

20. The anchoring system of claim 15, wherein the carrier further comprises a second stop tab and a channel between the first stop tab and the second stop tab,
wherein a second edge of the lock plate is configured to engage the second stop tab upon rotation of the bolt in the first direction, and
wherein rotation of the bolt in the first direction moves the lock plate along the shaft in a direction toward the face plate within the channel.

21. The anchoring system of claim 20, wherein the lock plate is prevented from rotating in a second direction opposite the first direction when the lock plate is disposed in the channel.

22. A method of attaching a tie-down assembly to a vehicle, comprising:
providing a tie-down assembly comprising:
a bolt comprising a head and a threaded shaft;
a face plate comprising an aperture configured to receive the bolt therethrough;
a carrier detachably coupled to the face plate, the carrier comprising a first stop tab; and
a lock plate comprising a first edge configured to engage the first stop tab and a threaded aperture configured to rotatably receive the bolt therethrough;
inserting the tie-down assembly through a hole in a wall of the vehicle such that the face plate contacts a first side of the wall, at least a portion of the carrier is disposed on a second side of the wall, and the lock plate is disposed on the second side of the wall in a first orientation;
rotating the bolt such that the lock plate rotates in a first direction to a second orientation where the first edge of the lock plate engages the first stop tab and such that lock plate moves along the shaft of the bolt in a direction toward the face plate.

23. The method of claim 22, wherein lock plate remains in the second orientation when rotating the bolt after engaging the first stop tab.
